(19) United States
(12) Patent Application Publication
(10) Pub. No.: US 2007/0148530 A1
(43) Pub. Date: Jun. 28, 2007

(54) Apparatus and substrate structure for growing carbon nanotubes

(75) Inventors: Chien-Liang Lin, Taipei (TW); Shu-Mei He, Hsinchu County (TW); Yi-Yie Yan, Hsinchu City (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Industrial Technology Research Institute

(21) Appl. No.: 11/315,464

(22) Filed: Dec. 22, 2005

(51) Int. Cl. H01M 4/00

(52) U.S. Cl. 429/44; 429/20

(57) ABSTRACT

The present invention provides an apparatus for growing carbon nanotubes, comprising a reaction chamber for receiving a substrate in a cylindrical form; and optionally a folding device for folding the substrate into a cylindrical form, which is arranged adjacent to the reaction chamber. A substrate structure in a reaction chamber for growing carbon nanotubes comprising a substrate in a cylindrical form is also provided.

### BACKGROUND OF THE INVENTION

The present invention relates to growth of carbon nanotubes, and more particularly, to an apparatus and substrate structure for growing carbon nanotubes applicable to development of large reaction area fuel cell.

Fuel cells are power generating systems that convert energy produced through the electrochemical reaction of fuel and oxidative gas directly into electric energy. With growing concerns about the environment and the depletion of energy resources, there is a growing need for the development of reliable, high-performance fuel cells with high energy efficiency.

Fuel cells, which are emerging as the next generation of a clean energy source alternative to fossil fuels, have high power density and high-energy conversion efficiency. And a proton-exchange membrane fuel cell (PEMFC) which uses hydrogen gas as a fuel source is one common type of fuel cells.

The basic structure of PEMFC as a power generator producing a direct current through the electrochemical reaction of hydrogen and oxygen is shown in FIG. 1. Referring to FIG. 1, a PEMFC has a proton-exchange membrane (PEM) 11 sandwiched between an anode and a cathode (electrode layers 12), and each of the electrode layers 12 is assembled from a catalyst layer (CL) 12a and a gas diffusion layer (GDL) 12b in such a way that the GDL 12b is in contact with a reaction gas, and the CL 12a is interposed between the GDL 12b and the PEM 11. The GDL 12b is formed of carbon cloth or carbon paper with a microporous layer made of carbon black and binder thereon. Since the GDL 12b provides a passage in the catalyst layer and serves as a structural support for the catalyst layer and current accumulation, the performance of the fuel cell is affected by the thickness, content and type of the carbon black in the GDL 12b. While the main type of the carbon black is currently Acetylene black, there is a growing concern of using carbon nano material such as carbon nanotubes (CNTs) in the development of the high performance fuel cell.

Recently, a thermal chemical vapor deposition (CVD) for synthesizing CNTs on a substrate by thermal decomposition of hydrocarbon, has been disclosed. The existing thermal CVD technique is advantageous in that high purity CNTs can be produced. In a PCT patent application, Publication No. WO2004/000728, the CNTs are formed in a reaction tube 22 by the thermal CVD. The combination of an electroconductive layer and a catalytic layer formed on a substrate is provided as an assembly 23, which is holding by a quartz holder 24, and heated by a heater 26 in the presence of hydrocarbon gas or other reaction gas as shown in FIG. 2.

In addition, an European Patent No. EP 1061041 disclosed a low-temperature thermal chemical vapor deposition apparatus and method of synthesizing CNTs. In FIG. 3, the apparatus has a reaction tube 1 divided into first and second regions (T1, T2) maintained at different temperatures, such that the carbon source gas is decomposed in the first region T1, which is a relatively high temperature region of the reaction tube 1. Then, the CNTs are synthesized over the surface of the substrate 5 using decomposed carbon source gas in the second region T2 whose temperature is lower than the first region T1.

While much research has been done on the formation of CNTs for various technologies, the formation of CNTs across large substrates has remained a challenge. Thus, there remains a need for growing CNTs across large substrates.

### BRIEF SUMMARY OF THE INVENTION

An aspect of the invention is to provide an apparatus for growing carbon nanotubes, which comprises a reaction chamber for receiving a substrate in a cylindrical form and optionally a folding device for folding the substrate into a cylindrical form, which is arranged adjacent to the reaction chamber.

Another aspect of the invention is to provide a substrate structure in a reaction chamber for growing carbon nanotubes which comprises a substrate in a cylindrical form, wherein the substrate is received in said reaction chamber for growing carbon nanotubes.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a schematic diagram illustrating a structure of a proton exchange membrane fuel cell (PEMFC);

FIG. 2 is a cross-sectional view illustrating a conventional apparatus for growing carbon nanotubes according to WO 2004/000728A1;

FIG. 3 is a cross-sectional view illustrating another conventional apparatus for growing carbon nanotubes in a reaction tube according to EP 1061041A1;

FIG. 4 is a cross-sectional view illustrating the apparatus for growing carbon nanotubes according to a first embodiment of the invention;

FIG. 5 is a cross-sectional view illustrating the apparatus for growing carbon nanotubes according to a second embodiment of the invention;

FIG. 6 is a cross-sectional view illustrating the apparatus for growing carbon nanotubes according to a third embodiment of the invention;

FIG. 7 is a cross-sectional view illustrating the apparatus for growing carbon nanotubes according to a fourth embodiment of the invention;

FIG. 8 is a cross-sectional view illustrating the apparatus for growing carbon nanotubes according to a fifth embodiment of the invention; and

FIG. 9 is a cross-sectional view illustrating the apparatus for growing carbon nanotubes according to a sixth embodiment of the invention.

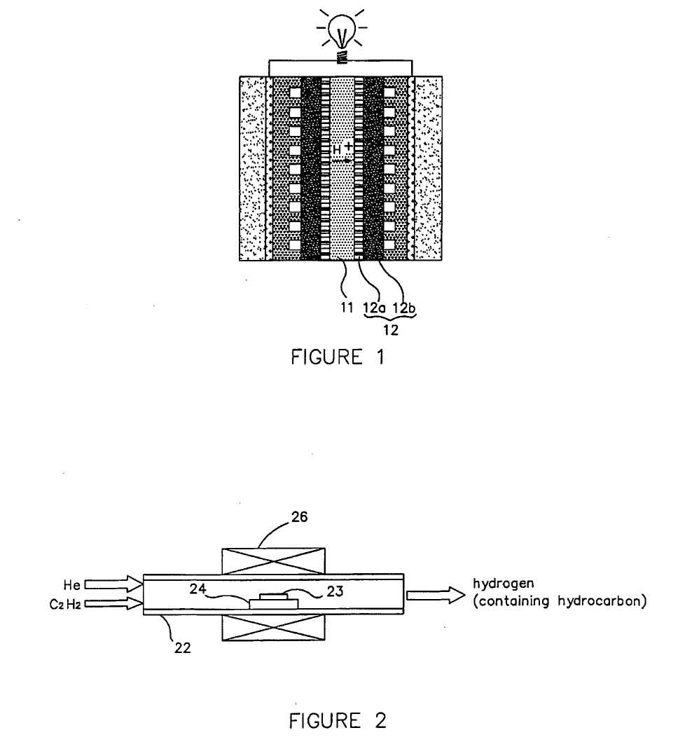

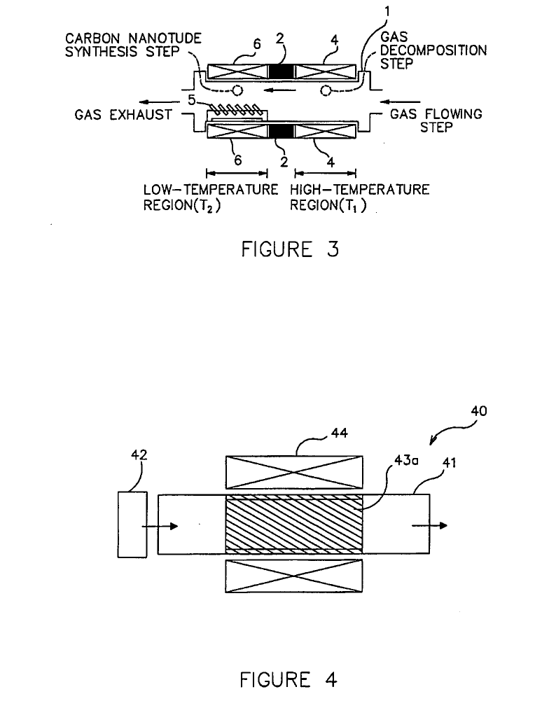

### DETAILED DESCRIPTION OF THE INVENTION

Reference will now be made in detail to the present embodiments of the invention, examples of which are illustrated in the accompanying drawings. Wherever possible, the same reference numbers will be used throughout the drawings to refer to the same or like parts.

The present invention provides an apparatus for growing carbon nanotubes. The apparatus includes a reaction chamber for receiving a substrate and a folding device for folding the substrate into a cylindrical form. The folding device is arranged adjacent to the reaction chamber.

According to the invention, the substrate can be made of a flexible substrate material, such as a carbon paper, carbon cloth, non-metal or metal material.

The apparatus further comprises a gas supply for providing a carbon-containing gas in the reaction chamber. The carbon-containing gas such as carbon monoxide (CO) or gaseous hydrocarbon compound including hydrocarbon gas or vapor may be supplied to react with the substrate in the reaction chamber. The carbon containing gas may be further mixed with other gases such as hydrogen (H₂), nitrogen (N₂), argon (Ar) or carbon dioxide (CO₂) for growing carbon nanotubes in the reaction chamber.

In accordance with one embodiment, the present invention provides the apparatus 40 for growing carbon nanotubes, which comprises the reaction chamber 41 for receiving the substrate 43, the folding device 42 for folding the substrate 43 into a cylindrical form, and the heating element 44 that is built adjacent to the reaction chamber 41. And the folding device 42 may be arranged external to the reaction chamber 41 as shown in FIG. 4.

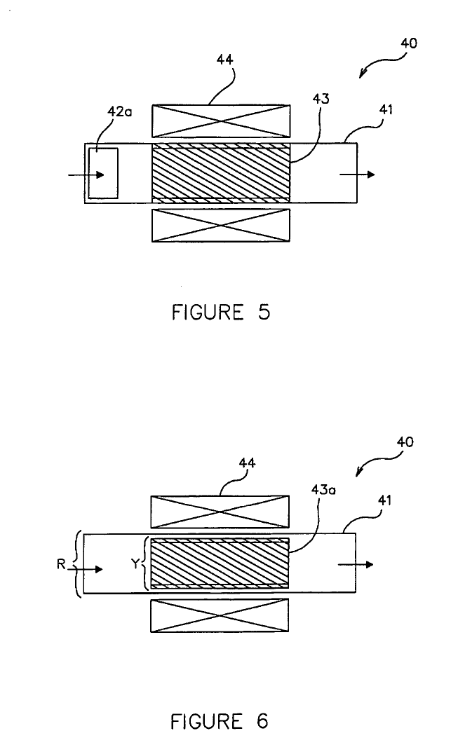

In accordance with another embodiment, the folding device 42a may also be a structure arranged or integrated within the reaction chamber 41 as shown in FIG. 5.

It is noted that the folding device is not limited to specific location relative to the reaction chamber described above as long as the substrate is folded into a cylindrical form before the growth of the carbon nano material takes place in the reaction chamber. And for simplicity of the diagram, the folding device is not illustrated in the subsequent drawings.

The substrate 43 is then folded into a cylindrical form by the folding device 42 which is arranged at the entry of the reaction chamber 41.

In accordance with another embodiment of the invention, the folding device 42 may be an open barrel. As the substrate 43 passes through the barrel, the substrate 43 is folded within the barrel into a cylindrical form that takes the shape of an inner wall of the barrel. The substrate 43 is then inserted into the reaction chamber 41 which is heated in the presence of the reaction gas by the heating element 44 for growing carbon nanotubes over the substrate 43.

In accordance with a further embodiment, the folding device 42 may also be a roller. As the substrate 43 is brought near to the roller, the substrate 43 is folded and wrapped around the roller into a cylindrical form.

In accordance with one other embodiment, the folding device 42 may be a hoop. As the substrate 43 passes through the hoop, the substrate 43 is folded by the hoop into a cylindrical form. Furthermore, the hoop includes and is not limited to a ring, a tubular cage, and a series of loops arranged as a solenoid.

In another embodiment, the folding device 42 may even be a binder that binds two opposite ends of the substrate 43 into a cylindrical form. For example, two opposite ends of the substrate 43 are fastened together by soldering or other adhesives into a cylindrical form.

The heating element 44 may be a heater which adopts heating by electrical resistance or by infra red irradiation. And the heating element 44 may be arranged either within the reaction chamber 41 or surrounding the reaction chamber 41. Therefore, the reaction chamber 41 is usually made of material which withstands high temperature and causes the least pollution. Preferably, the reaction chamber 41 is made of a quartz tube.

In accordance with one embodiment, the heating element 44 is arranged as shown in FIGS. 4 and 5. The heat element 44 is surrounding the reaction chamber in such as a way that the substrate 43 in the reaction chamber 41 is heated indirectly by the heat that passes through the wall of the reaction chamber 41 to the substrate 43. The reaction gas that passes through the reaction chamber 41 also gets heated to initiate the thermal chemical vapor deposition, so that carbon nanotubes are grown on the substrate 43.

In accordance with another embodiment, the substrate 43a may be folded into a cylindrical form having a diameter (r) substantially smaller than a diameter (R) of the reaction chamber 41. Referring to FIG. 6, a gap or hollow space is also formed between the inner wall of the reaction chamber 41 and the substrate 43a as the substrate 43a is received in the reaction chamber 41. Therefore, reaction gas may freely pass through the gap or hollow space to ensure that carbon nanotubes are grown on both inner and outer surfaces of the substrate 43a to increase the overall growth area.

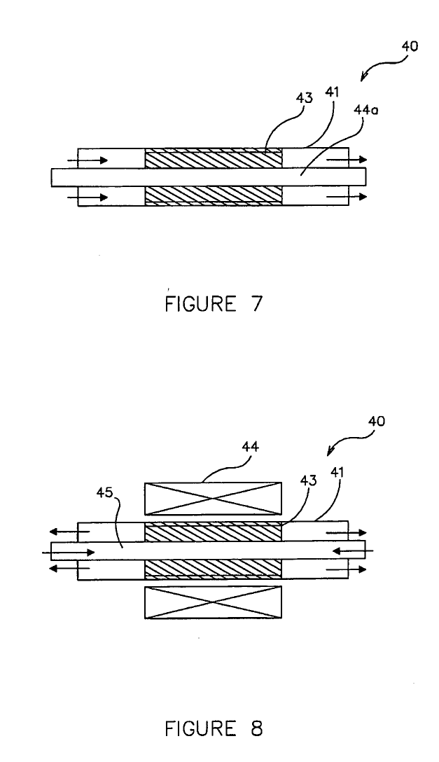

In accordance with another embodiment, the heating element 44a is arranged within the reaction chamber 41. Referring to FIG. 7, the heating element 44a such as a heating pipe is provided in the axis of the reaction chamber 41 to ensure that the substrate 43 is heated directly by the heating element 44a. Thus, the reaction gas is efficiently decomposed to provide species required in the thermal chemical vapor deposition.

In accordance with a further embodiment, the reaction chamber 41 further comprising a pipe 45 running through the reaction chamber 41 for supplying the carbon-containing gas in the reaction chamber 41. Referring to FIG. 8, the pipe 45 has a plurality of pores (indicated by the arrows pointing out from the pipe 45) thereon to evenly distribute the carbon-containing gas within the reaction chamber 41. The carbon-containing gas may be supplied from both ends of the pipe 45 towards the pores. Preferably, each of the pores has a diameter of about 0.1 mm to about 5 mm to allow direct flow of the carbon-containing gas towards the surface of the substrate 43, while the unreacted portion of the carbon-containing gas is then discharged out through the two open ends of the reaction chamber 41. This improves from the problem associated with laminar flow of the fluid when the carbon-containing gas is flowing parallel to the surface of the substrate 43.

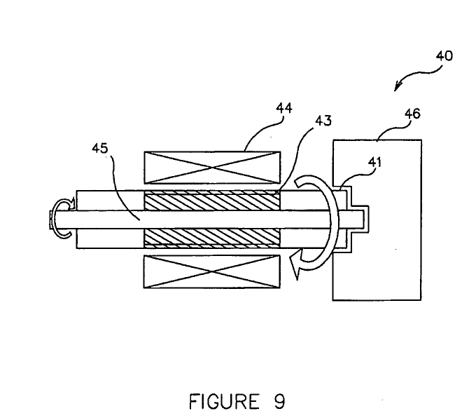

In accordance with one other embodiment, the pipe 45 and the reaction chamber 41 may be rotated using a rotating device 46 to further improve distribution of the carbon nanotubes grown on the substrate 43. Referring to FIG. 9, the pipe 45 may be rotated at an opposite direction from the reaction chamber 41. The pipe 45 and reaction chamber 41 are preferably rotated at a spin rate of about 0 to about 100 revolutions per minute (rpm). However, the present invention shall not be limited to those described in the embodiment. It is understood by one having ordinary skills in the art that both the pipe 45 and the reaction chamber 41 may also be rotated at the same direction to achieve even distribution of the carbon nanotubes grown on the substrate 43.

In light of the apparatus described above, the present invention also provides a substrate structure in a reaction chamber for growing carbon nanotubes which comprises a substrate in a cylindrical form, wherein the substrate in a cylindrical form is received in said reaction chamber for growing carbon nanotubes.

In accordance with one embodiment, the substrate is made from a flexible substrate material which includes but is not limited to a carbon paper, carbon cloth, non-metal or metal material.

The substrate is folded into a cylindrical form by a folding device. According to one embodiment of the invention, the folding device is a selected from a group consisting of an open barrel, a roller, a hoop and a binder that binds two opposite sides of the substrate.

According to one further embodiment, the substrate 43a may be folded into a cylindrical form having a diameter (r) substantially smaller than a diameter (R) of the reaction chamber 41 as shown in FIG. 6. As a result, the reaction gas may freely pass through a gap or hollow space between the inner wall of the reaction chamber 41 and the substrate 43a to ensure that carbon nanotubes are grown on both inner and outer surfaces of the substrate 43a to increase the overall growth area.

While the substrate may be folded into other similar configurations, such as arc, sector and cone to increase its surface area for growing carbon nanotubes, these configurations also fall within the scope of the present invention.

Summarizing from the above, the present invention provides an apparatus and substrate structure for growing carbon nanotube on an area of the substrate which is enlarged by at least π (about 3.14) times when the substrate is folded into a cylindrical form. Therefore, a large area of the carbon nanotubes is grown on the substrate in the reaction chamber, and the fuel cell is manufactured as a result with improved efficiency. In addition, the carbon nanotubes grown as described above may be applicable to manufacturing of carbon nanotubes for filtering and electrodes of the electrochemical battery, such as fuel cells, lithium battery, and zinc-air battery.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1. An apparatus for growing carbon nanotubes, comprising
a reaction chamber for receiving a substrate in a cylindrical form; and
optionally a folding device for folding the substrate into a cylindrical form, which is arranged adjacent to the reaction chamber.

2. The apparatus according to claim 1, wherein the substrate is made from a flexible substrate material.

3. The apparatus according to claim 2, wherein the flexible substrate material is carbon paper, carbon cloth, non-metal or metal material.

4. The apparatus according to claim 1, wherein the folding device is selected from a group consisting of an open barrel, a roller, a hoop and a binder that binds two opposite sides of the substrate.

5. The apparatus according to claim 1, further comprising a gas supply for providing a carbon-containing gas in the reaction chamber.

6. The apparatus according to claim 1, further comprising a heating element surrounding the reaction chamber.

7. The apparatus according to claim 5, wherein the gas supply for providing a carbon-containing gas is a pipe running through the reaction chamber.

8. The apparatus according to claim 7, wherein the pipe has a plurality of pores for distributing the carbon-containing gas within the reaction chamber.

9. The apparatus according to claim 6, further comprising a rotating device for rotating the reaction chamber and the pipe.

10. The apparatus according to claim 1, wherein the substrate in a cylindrical form having a diameter substantially smaller than a diameter of the reaction chamber.

11. A substrate structure in a reaction chamber for growing carbon nanotubes comprising a substrate in a cylindrical form, wherein the substrate is received in said reaction chamber for growing carbon nanotubes.

12. The substrate structure according to claim 11, wherein the substrate is made from a flexible substrate material.

13. The substrate structure according to claim 12, wherein the flexible substrate material is carbon paper, carbon cloth, non-metal or metal material.

14. The substrate structure of claim 11, wherein the substrate in a cylindrical form has a diameter substantially smaller than a diameter of the reaction chamber.
